(19) United States
(12) Patent Application Publication
(10) Pub. No.: US 2007/0235309 A1
(43) Pub. Date: Oct. 11, 2007

(54) Waterproof structure of electronic device

(75) Inventor: Ming-Yang Tsu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/401,360

(22) Filed: Apr. 11, 2006

(51) Int. Cl. B41J 5/00; H01H 1/10

(52) U.S. Cl. 200/515; 400/472

(57) ABSTRACT

A waterproof structure of an electronic device is provided for protecting an electronic device. The electronic device, such as a notebook, includes a case, a keyboard, and a plurality of electronic elements. An opening is formed on the case for accommodating the keyboard. Electronic elements of the electronic device are arranged under the keyboard. The waterproof structure includes at least a water-absorbing element disposed in the case and near the opening. Further, the water-absorbing element is disposed between the electronic elements and the opening for absorbing the water leaking from the keyboard, so as to prevent the water from leaking from the opening into the case and resulting in damage to the electronic elements.

### BACKGROUND OF THE INVENTION

1. Field of Invention

The present invention relates to a waterproof structure of an electronic device, and more particularly, to a waterproof structure for enhancing the waterproof performance by absorbing the water.

2. Related Art

With the increasing development of semiconductor technology, electronic devices have played an important role in modern equipment, such as clocks, mobile phones, digital cameras, and computers. For example, the notebook has become an important mobile equipment in the life of an office worker. When using or carrying the notebook, water from rain or other circumstances often leaks from the keyboard into the notebook and results in damages. Therefore, in the current notebook, a suitable waterproof method for various parts has been provided. For example, a waterproof coating or a waterproof film is coated on the surface of the parts of the notebook, so as to prevent water from leaking into the notebook. Alternatively, a protective layer for preventing the water from leaking is utilized under the keyboard, so as to prevent the electronic circuits under the keyboard from being damaged. Although the protective layer can prevent the water from leaking, the water can not be removed effectively. The leaked water will accumulate on the protective layer and finally leaks into the notebook.

Moreover, during the manufacturing of each notebook, products are subjected to many tests. The waterproof test (anti-spill test) is one of the most important testing items. The object of the testing is that each notebook should operate normally if coffee or coke is spilled on the notebook when being used by the users. The testing method relates to spilling 30 c.c. of coffee or coke on the keyboard, and testing whether each function of the system can be operated normally 1 minute later. In the past, in order to pass the waterproof test, a mylar film is stuck to the backside of the keyboard for preventing water from leaking from the holes or surrounding gaps of the keyboard. However, with this method, when there is a large amount of water, the water will leak from the keyboard to the circuit board, which easily causes damage to the system.

### SUMMARY OF THE INVENTION

In view of the above problems, a major object of the present invention is to provide a waterproof structure of electronic device, which is used for preventing water from leaking into the electronic device and results in damages, by absorbing the water occasional leaking into the electronic device.

In order to achieve the object, a waterproof structure of electronic device is provided. The waterproof structure of electronic device has at least a water-absorbing element, which is used to absorb the water leaking through the keyboard. The water-absorbing element includes at least a liquid-permeable layer and an absorbing layer. The water leaking through the keyboard is absorbed by the absorbing layer through the liquid-permeable layer. And the liquid-permeable layer can be a thermal-bonding non-woven fabric and the absorbing layer can be made of water-absorbing polymer material, e.g. water-absorbing resin powder. When the water-absorbing element contacts the water, the water is absorbed quickly by the thermal-bonding non-woven fabric and transmitted to the water-absorbing resin. The water-absorbing resin powder will expand as a jelly-like substance after absorbing water. So the leaked water will not go on dripping in the case and result in damage to electronic elements, such as circuit boards.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It is to be understood that both the foregoing general description and the following detailed description are exemplary, and are intended to provide further explanation of the invention as claimed.

### BRIEF DESCRIPTION OF THE DRAWINGS

The present invention will become more fully understood from the detailed description given herein below for illustration only, and which thus is not limitative of the present invention, and wherein:

FIG. 1 is a first embodiment of a waterproof structure of electronic device applied in a notebook according to the present invention;

FIG. 2 is a second embodiment of the waterproof structure of electronic device applied in a notebook according to the present invention; and

FIG. 3 is a third embodiment of the waterproof structure of electronic device applied in a notebook according to the present invention.

### DETAILED DESCRIPTION OF THE INVENTION

In order to make a further understanding of the objects, constructions, features, and functions of the present invention, the present invention will be described in detail with the embodiments below.

A waterproof structure of electronic device provided according to the present invention can be applied in various portable electronic devices, such as computer, translating machine, portable computer, and notebook. The waterproof structure has a water-absorbing element arranged in a suitable position in the case of the electronic device, for preventing water from leaking into the electronic device by absorbing the water occasional leaking into the electronic device. The detailed construction and effects related to the waterproof structure of the electronic device will be described with a preferred embodiment below.

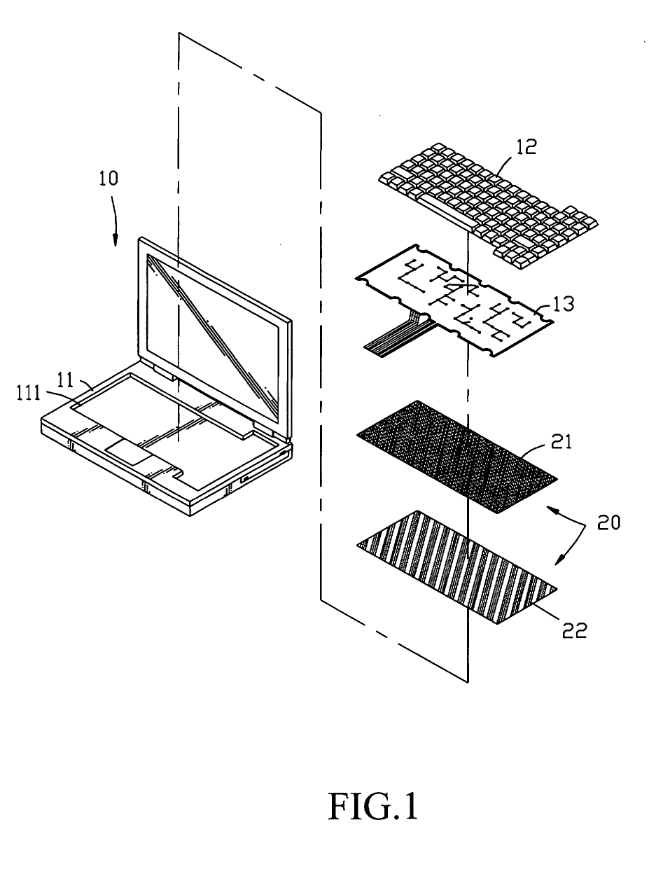

Referring to FIG. 1, the waterproof structure of electronic device provided by the first embodiment of the present invention is used to protect an electronic device. And the electronic device is a notebook 10 in the present embodiment.

The notebook 10 has a case 11 and a keyboard 12. A plurality of electronic elements 13 is disposed under the keyboard 12. An opening 111 is formed on the case 11 for accommodating the keyboard 12, and is covered by the keyboard 12. The electronic elements 13 are disposed in the case 11 under the keyboard 12.

The waterproof structure includes at least a water-absorbing element 20 disposed inside the opening 111. The water-absorbing element 20 is disposed between the electronic elements 13 and the opening 111, blocking the holes and gaps between the keyboard 12 and the opening 111 from the inside of the case 11, for absorbing the water leaking from the edges of the keyboard 12 and the opening 111. So the water is prevented from leaking from the opening 111 to the case 11 and resulting in damage to the electronic elements 13 accommodated in the case 11. Also, waterproof structure prevents water on the keyboard 12 continuing to leak, so that damages to the electronic elements 13 are prevented.

The water-absorbing element 20 includes at least a liquid-permeable layer 21 and an absorbing layer 22. The water leaking into the keyboard 12 is passing through the liquid-permeable layer 21 and absorbed by the absorbing layer 22. And the liquid-permeable layer 21 can be a thermal-bonding non-woven fabric and the absorbing layer 22 can be made of water-absorbing polymer material, e.g. water-absorbing resin powder. When the water-absorbing element 20 contacts the water, the water is absorbed quickly by the thermal-bonding non-woven fabric and transmitted to the water-absorbing resin. The water-absorbing resin powder will expand as a jelly-like substance after absorbing water. So the water will not go on drip in the case 11 and will not stay on the keyboard 12 to result in damage to the electronic elements 12, such as circuit boards.

After the object of waterproofing is achieved by absorbing water with the water-absorbing element 20 and the user needs to replace the water-absorbing element 20, he or she needs only to dismount the keyboard 12 from the opening 111 to easily replace it with a new water-absorbing element, so as to ensure the efficiency of the waterproof structure.

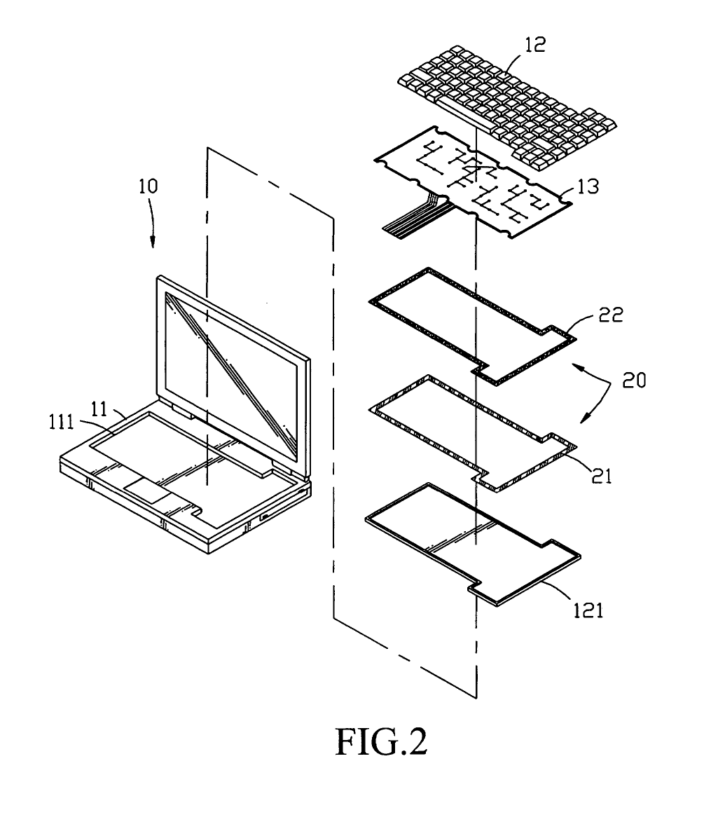

Referring to FIG. 2, it is a schematic diagram of a second embodiment of the waterproof structure of electronic device according to the present invention. The waterproof structure is still used to protect an electronic device, for example, a notebook 10. The construction features of the notebook 10 are the same as that of the first embodiment, so the same element names and symbols will be used as well. The water-absorbing element 20 is a ring, which is disposed on the side of the opening 111 and between the keyboard 12 and the case 11, and suitable for absorbing water leaking from the keyboard 12 quickly and directly. It should be further illustrated that the keyboard 12 further includes a bottom cover 121, and the water-absorbing element 12 is stuck to the bottom cover 121. The water-absorbing element 20 of the embodiment absorbs water leaking into the bottom cover 121 from the keyboard 12, therefore, the liquid-permeable layer 21 in the present embodiment is stuck against the bottom cover 121, thereby absorbing the water received by the bottom cover 121 land transmitting the water to the absorbing layer 22 to be absorbed.

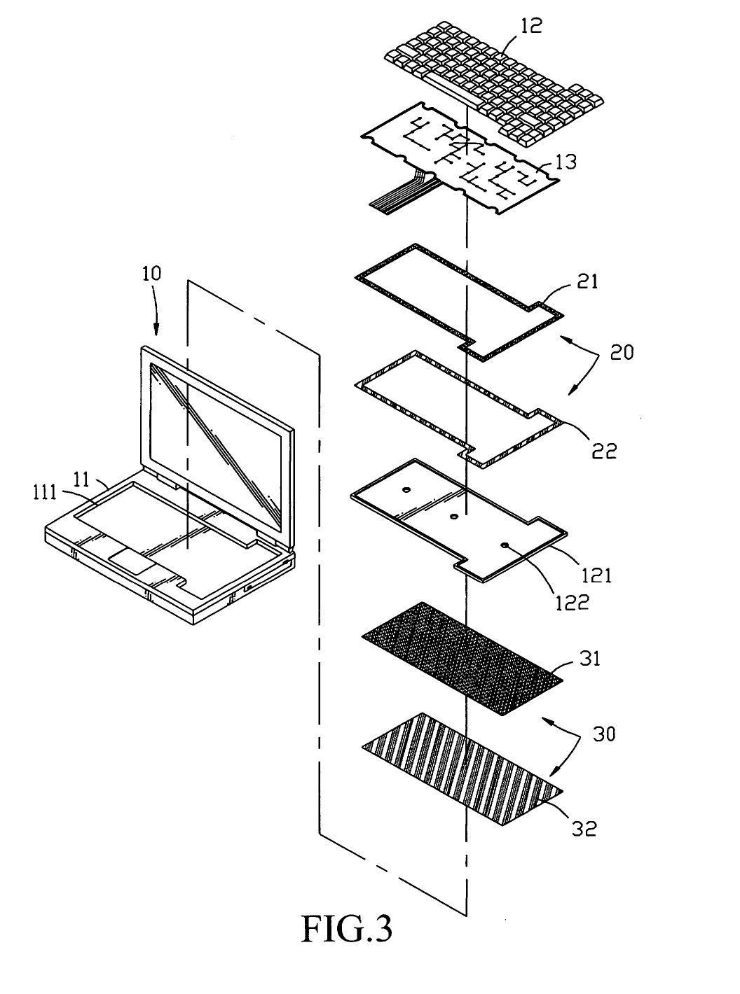

Referring to FIG. 3, it is a schematic diagram of a third embodiment of the waterproof structure of electronic device according to the present invention. In the embodiment, the waterproof structure includes at least two water-absorbing elements 20, 30 respectively disposed on the side of the opening 111 and between the keyboard 12 and the case 11, and disposed between the case 11 and the bottom cover 121. The bottom cover 121 has at least one aperture 122, for exhausting the redundant water from the bottom cover 121 to be absorbed by the water-absorbing element 30 disposed between the case 11 and the bottom cover 121. And the water-absorbing element 30 has a liquid-permeable layer 31 and an absorbing layer 32 as well.

To sum up, in the present invention, a water-absorbing element 20 or another water-absorbing element 30 further disposed are used for absorbing water accidentally leaking into the case 11 from the keyboard 12, such that the water will not flow randomly any more to damage any electronic elements, therefore the object of waterproofing is achieved efficiently.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A waterproof structure of an electronic device for protecting an electronic device having at least a case and a keyboard, wherein an opening is formed on the case for accommodating the keyboard, and the waterproof structure comprises:
a water-absorbing element, disposed in the opening and on one side in the case, for absorbing the water leaking from the keyboard and the edges of opening.

2. The waterproof structure of electronic device of claim 1, wherein a plurality of electronic elements are disposed in the case under the keyboard, and the water-absorbing element is disposed between the plurality of electronic elements and the keyboard.

3. The waterproof structure of electronic device of claim 2, wherein the water-absorbing element comprising a liquid-permeable layer and an absorbing layer.

4. The waterproof structure of electronic device of claim 3, wherein the absorbing layer is made of water-absorbing polymer material.

5. The waterproof structure of the electronic device of claim 4, wherein the absorbing layer is made of water-absorbing resin.

6. The waterproof structure of electronic device of claim 3, wherein the liquid-permeable layer is made of thermal-bonding non-woven fabric.

7. The waterproof structure of electronic device of claim 1, wherein the water-absorbing element is a ring disposed on the side of the opening.

8. The waterproof structure of electronic device of claim 1, wherein the keyboard further comprises a bottom cover and the water-absorbing element is stuck to the bottom cover.

9. The waterproof structure of electronic device of claim 8, wherein the water-absorbing element has a liquid-permeable layer and an absorbing layer, and the liquid-permeable layer is stuck to the bottom cover.

10. The waterproof structure of electronic device of claim 8, wherein the bottom cover has at least one aperture for exhausting the redundant water from the bottom cover to be absorbed by the water-absorbing element disposed between the case and the bottom cover.
